(19) United States
(12) Patent Application Publication
(10) Pub. No.: US 2017/0295488 A1
(43) Pub. Date: Oct. 12, 2017

(54) METHOD FOR GENERATING A KEY AND METHOD FOR SECURE COMMUNICATION BETWEEN A HOUSEHOLD APPLIANCE AND AN APPLIANCE

(71) Applicant: Miele & Cie. KG, Guetersloh (DE)

(72) Inventors: Nils Langhammer, Verl (DE); Thomas Koester, Bielefeld (DE); Stefan Woestemeyer, Salzkotten (DE)

(21) Appl. No.: 15/478,271

(22) Filed: Apr. 4, 2017

(30) Foreign Application Priority Data
Apr. 6, 2016 (DE) 102016106231.6

(51) Int. Cl. H04W 12/04; H04L 29/06; H04L 9/08

(52) U.S. Cl. CPC H04W 12/04; H04L 9/0866; H04L 9/0869; H04L 63/067; H04L 63/0435

(57) ABSTRACT

A method for generating a key for secure communication between a household appliance and an appliance includes the following steps: determining the key using identification information associated with the household appliance; and sending the identification information via an air interface of the household appliance in order to transmit the identification information from the household appliance to the appliance.

### CROSS-REFERENCE TO PRIOR APPLICATION

Priority is claimed to German Patent Application No. DE 10 2016 106 231.6, filed on Apr. 6, 2016, the entire disclosure of which is hereby incorporated by reference herein.

### FIELD

The present invention relates to a method for generating a key for secure communication between a household appliance and an appliance, a method for secure communication between a household appliance and an appliance, and to a corresponding device, as well as a household appliance including such a device.

### BACKGROUND

A field service technician may diagnose a household appliance using a diagnostic device.

### SUMMARY

In an embodiment, the present invention provides a method for generating a key for secure communication between a household appliance and an appliance, the method comprising the following steps: determining the key using identification information associated with the household appliance; and sending the identification information via an air interface of the household appliance in order to transmit the identification information from the household appliance to the appliance.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a household appliance and an appliance;

FIG. 2 is a flow diagram of a method for generating a key in a household appliance;

FIG. 3 is a flow diagram of a method for generating a key in an appliance;

FIG. 4 is a flow diagram of a method for determining a key; and

FIG. 5 is a flow diagram of a method for secure communication between a household appliance and an appliance.

### DETAILED DESCRIPTION

In an embodiment, the present invention provides a method for generating a key for secure communication between a household appliance and an appliance, a method for secure communication between a household appliance and an appliance, a corresponding device, as well as a household appliance having the features of the main claims. Advantageous embodiments and refinements of the present invention will become apparent from the following dependent claims.

Among the advantages provided by the present invention is that it allows an appliance, such as, for example, a diagnostic device, to be coupled to a household appliance via a wireless communication connection and, moreover, that it allows the communication connection to be protected by keys which are generatable in the household appliance and the appliance.

A method for generating a key for secure communication between a household appliance and an appliance includes the following steps:

determining the key using identification information associated with the household appliance and a general key; and

sending the identification information via an air interface of the household appliance in order to transmit the identification information from the household appliance to the appliance.

The household appliance may be, for example, an appliance for preparing or cooling foods, for cleaning dishes or laundry, or a vacuum cleaner. Such a household appliance may also be used in commercial applications. Communication may be via a suitable communication connection, in particular via a wireless communication connection. The appliance may be a mobile device, such as, for example, a diagnostic device, which may be used by a field service technician, for example, to read the fault memory of the household appliance or to install software on the household appliance. Alternatively, the appliance may be another household appliance. The key may be a cryptographic key, such as is used in known encryption methods. The identification information may be data suitable for uniquely identifying the household appliance. In accordance with an embodiment, the key may further be determined using a general key. The identification information and, if applicable, the general key may be data stored or storable in the household appliance.

According to an embodiment of the method, the determining step may be performed using a determining unit disposed or disposable in the household appliance. This allows the key to be generated autonomously in the household appliance.

The method may include a step of reading the identification information and, if applicable, the general key via an interface to a storage unit for storing the identification information and, if applicable, the general key. The storage unit may represent a storage unit which is disposed or disposable in the household appliance. Such a storage unit allows the data required for generating the key to be stored in the household appliance, for example, during the manufacture thereof.

The reading step may, for example, be performed in response to an activation of an air interface of the household appliance for wireless communication between the household appliance and the appliance. The air interface may be activated, for example, by a field service technician who wants to establish a secure communication connection between the household appliance and the appliance.

The method may further include a step of providing the identification information to the already mentioned air interface or an additional air interface of the household appliance for transmitting the identification information from the household appliance to the appliance. The identification information provided to the air interface may be sent unencrypted via the air interface and used by the appliance to generate the key as well. This allows corresponding keys to be generated in both the household appliance and the appliance, the keys enabling secure communication between the household appliance and the appliance.

The method may include a step of establishing a (soft) AP of an infrastructure-based network. The identification information may be part of the name of the network.

For example, the identification information may be transmitted as part of a network name of the air interface. By (possibly repeatedly) sending the network name, the air interface may be identified by an air interface disposed in the appliance. The sending of the network name is a typical procedure for establishing a wireless network. Thus, the identification information may be sent without additional effort by incorporating it into the network name.

In a providing step, the key for encrypting or decrypting data to be transmitted via the air interface may be provided. This allows the communication connection between the household appliance and the appliance to be protected by using the generated and provided key.

The identification information may represent a serial number of the household appliance. This is advantageous because serial numbers are typically unique. If, in addition, a general key is used for generating the key, then this general key may represent a key assigned to a plurality of household appliances. The general key may also be stored in the appliance, so that there is no need to transmit the general key from the household appliance to the appliance.

In accordance with an embodiment, in the determining step, the key may be determined further using a randomly generated parameter. The randomly generated parameter may represent a parameter which is generated using a random number generator or a pseudo-random number generator. The randomly generated parameter may be generated in the household appliance and transmitted unencrypted via the air interface to the appliance, for example, together with the identification information as part of the already mentioned network name. Alternatively, the randomly generated parameter may be generated in the appliance and transmitted unencrypted via the air interface to the household appliance. In accordance with an embodiment, each activation of the air interface may cause a new randomly generated parameter to be generated and used for determining the key. This allows the communication between the household appliance and the appliance to be made a very secure. The parameter may be valid for one connection only and then become invalid, and may be determined anew in a subsequent determining step. In the sending step, the parameter may be sent together with the identification information.

In accordance with an embodiment, in the determining step, a first pre-key may be determined from the identification information and, if applicable, the general key using a cryptographic signature method. The cryptographic signature method may be a common signature method, such as one using a hash function. Such signature methods make it possible to generate secure keys. If the key is not generated directly from the first pre-key or does not already correspond to the first pre-key, a second pre-key may be determined from the first pre-key using a transformation rule. The transformation rule may, for example, be suitable for transforming a first pre-key in the form of binary data into an ASCII character string. Advantageously, a format of the first pre-key may be adapted by the transformation rule to a format that can be used by the air interface. If the key does not already correspond to the second pre-key, the key may be determined from the second pre-key using a length adjustment rule. Such a length adjustment rule may be used to adjust a length of the second pre-key to a length required for the key. If the second pre-key must be shortened, the length adjustment rule used may be a trimming rule making it possible, for example, to remove excess digits of the second pre-key.

A method for secure communication between a household appliance and an appliance includes the following steps:

generating a first key using a first determining unit disposed in the household appliance and performing the aforementioned method for generating a key;

generating a second key corresponding to the first key using a second determining unit disposed in the appliance and using the identification information sent via the air interface; and

establishing a secure communication connection between the household appliance and the appliance using the first key and the second key.

Advantageously, the keys may thus be generated in the household appliance and the appliance using the same identification information.

The approach presented here also provides a device that is adapted for performing, controlling and implementing the steps of a variant of a method presented here in corresponding units. The object underlying the present invention may also be achieved rapidly and efficiently by this embodiment variant of the present invention in the form of a device.

The device may be adapted to read input signals and determine and provide output signals on the basis of the input signals. An input signal may be, for example, a sensor signal which can be read via an input interface of the device. An output signal may be a control signal or a data signal which can be provided at an output interface of the device. The device may be adapted to determine the output signals on the basis of a processing rule implemented in hardware or software. For this purpose, the device may, for example, include a logic circuit, an integrated circuit or a software module, and may, for example, be implemented as a discrete device or may be included in a discrete device.

Also advantageous is a computer program product or computer program having program code which may be stored on a machine-readable carrier or storage medium, such as a semiconductor memory, a hard-disk memory or an optical memory. If the program product or program is executed on a computer or a device, then the program product or program can be used to perform, implement and/or control the steps of the method in accordance with one of the above-described embodiments.

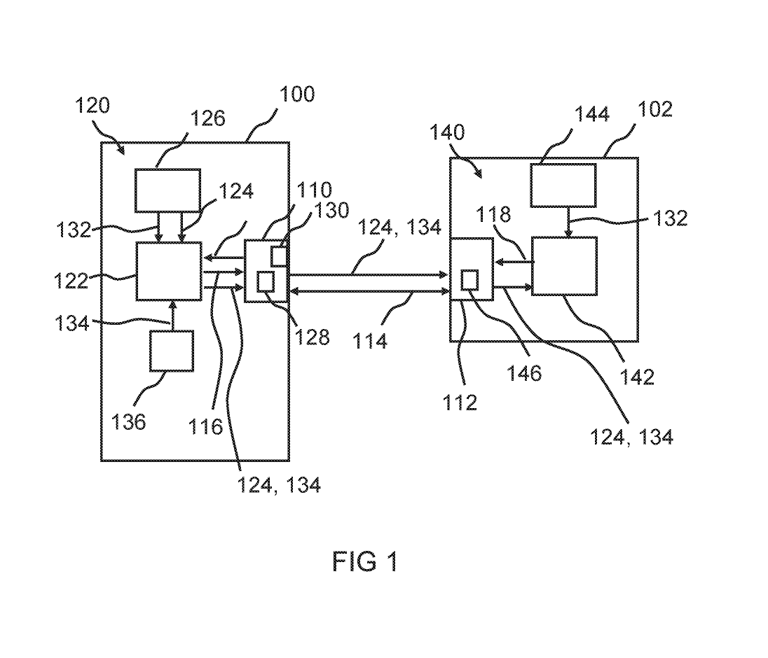

FIG. 1 schematically shows a household appliance 100 and an appliance 102 in accordance with an exemplary embodiment. Household appliance 100 is a networkable device and, in particular, a wirelessly networkable device, which may be used in a private or commercial environment. Merely by way of example, household appliance 100 represents a refrigerator having a refrigeration compartment for storing foods. In accordance with this exemplary embodiment, appliance 102 takes the form of a diagnostic device. Alternatively, appliance 102 may be any other device capable of being networked with the household appliance, such as, for example, another household appliance. The appliance 102 shown here may be a device for maintenance or diagnosis, such as is used, for example, by field service personnel for maintenance of household appliances 100. In accordance with this exemplary embodiment, appliance 102 is a mobile device which is spaced from household appliance 100 by a distance smaller than a maximum range of a wireless network connection via which appliances 100, 102 may be coupled to each other. Diagnostic device 102 may take the form of a PC, laptop, tablet, smartphone or the like. The wireless network connection may be based on a known standard. For example, the wireless network connection may be a WLAN-based connection.

To be able to establish a data transmission connection between appliances 100, 102, household appliance 100 has a first air interface 110 and diagnostic device 102 has a second air interface 112. Via air interfaces 110, 112, a secure communication connection 114, such as, for example, a bidirectional connection, may be established between household appliance 100 and diagnostic device 102 for wireless data transmission. An air interface 110, 112 may be understood to be a radio module, for example. Secure communication connection 114 is protected by an encryption method using a first key 116 and a second key 118 corresponding to first key 116. In accordance with an exemplary embodiment, first and second keys 116, 118 are identical. According to the approach described herein, first key 116 is generated in household appliance 100 and second key 118 is generated in diagnostic device 102. Secure communication connection 114 is protected in that the data sent via first air interface 110 is encrypted using first key 116, the data sent via second air interface 112 is encrypted using second key 118, the data received via first air interface 110 is decrypted using first key 116, and the data received via second air interface 112 is decrypted using second key 118.

In order to generate first key 116, household appliance 100 has a first device 120 for generating first key 116 for secure communication between household appliance 100 and diagnostic device 102. First device 120 may be completely or partially integrated into a controller of household appliance 100 or implemented as an independent device incorporated into household appliance 100. First device 120 has a first determining unit 122 adapted to determine first key 116 using identification information 124 associated with household appliance 100, such as, for example, a serial number or any other character string for identifying household appliance 100. Identification information 124 is stored in first determining unit 122 or, as shown in FIG. 1, in a storage unit 126 of household appliance 100.

In order to generate first key 116, first determining unit 122 is adapted to read identification information 124 from storage unit 126. First determining unit 122 is adapted to generate first key 116 using a key generation rule, such as is typically used for generating keys. For example, the key generation rule may be based on a hash function. Once first key 116 has been determined, it is made available for encrypting and decrypting data transmitted via secure communication connection 114. In accordance with this exemplary embodiment, first key 116 is provided to first air interface 110, which has a unit 128 for encrypting and decrypting data and an antenna for wireless data transmission.

According to an exemplary embodiment, the process of generating first key 116 is initiated by an activation signal 129 received by determining unit 122. For example, activation signal 129 is provided in response to activation of first air interface 110. In accordance with an exemplary embodiment, activation signal 129 is provided when an operator presses a button 130 on household appliance 100.

According to an exemplary embodiment, first determining unit 122 is adapted to determine the first key further using a general key 132. General key 132 is a key which may be stored in a plurality of household appliances 100 and, unlike the identification information, is therefore not suitable for uniquely identifying household appliance 100. In accordance with this exemplary embodiment, general key 132 is also stored in storage unit 126, and first determining unit 122 is adapted to read general key 132 together with identification information 124 from storage unit 126 and to use it for determining first key 116.

According to an exemplary embodiment, first determining unit 122 is adapted to determine the first key using a randomly generated parameter 134 alternatively or in addition to general key 132. In accordance with an exemplary embodiment, device 120 has a unit 136 for randomly or pseudo-randomly generating randomly generated parameter 134. In an exemplary embodiment, unit 136 is adapted to generate a new randomly generated parameter 134 each time a new first key 116 is determined. For example, a new randomly generated parameter 134 may be generated in response to the provision of the activation signal. Thus, each newly determined first key 116 is based on a random component.

In order to generate second key 118, diagnostic device 102 has a second device 140 for generating second key 118 for secure communication between household appliance 100 and diagnostic device 102. Second device 140 has a second determining unit 142 adapted to determine second key 118 using identification information 124 associated with household appliance 100. In accordance with an exemplary embodiment, identification information 124 is not stored in diagnostic device 102, but sent by household appliance 100 and received by diagnostic device 102. To this end, first air interface 110 of household appliance 100 is adapted to send identification information 124, and second air interface 112 of diagnostic device 102 is adapted to receive identification information 124 and provide it to second determining unit 142. First air interface 110 is adapted, for example, to receive identification information 124 from first determining unit 122 or read it from storage unit 126. According to an exemplary embodiment, first air interface 110 is adapted to send the identification information as part of a network name used by the first air interface. The network name may be sent unencrypted. First air interface 110 may, for example, be understood as a router or access point and second air interface 112 may be understood as a client.

Second determining unit 142 is adapted to determine second key 118 in the same way, for example, using the same key generation rule, in which first determining unit 122 determines first key 116.

If first key 116 is determined using randomly generated parameter 134, then randomly generated parameter 134 is also transmitted, for example, together with identification information 124, from first air interface 110 to second air interface 112 and provided to second determining unit 142. Randomly generated parameter 134 may also be sent as part of the network name.

If first key 116 is determined using general key 132, then second key 118 is also determined using general key 132. In accordance with an exemplary embodiment, general key 132 is stored in a storage unit 144 of diagnostic device 102, and second determining unit 142 is adapted to read general key 132 from storage unit 144 and to use it for determining second key 118.

Once second key 118 has been determined, it is made available for encrypting and decrypting data transmitted via secure communication connection 114. In accordance with this exemplary embodiment, second key 118 is provided to second air interface 110, which has a unit 146 for encrypting and decrypting data.

According to an exemplary embodiment, determining units 122, 142 are each adapted to initially determine a first pre-key from identification information 124 and general key 132 using a cryptographic signature method, to subsequently determine a second pre-key from the first pre-key using a transformation rule, and to then determine keys 116, 118 from the second pre-key, in each case using a trimming rule.

Once keys 116, 118 have been generated in household appliance 100 and diagnostic device 102, keys 116, 118 are used for running secure communication connection 114 between household appliance 100 and diagnostic device 102.

In accordance with an exemplary embodiment, field service personnel may further diagnose household appliance 100 via an optical interface. Communication via the optical interface is performed unencrypted because eavesdropping by third parties is impossible due to the characteristics of optical transmission. To this end, the field service personnel establishes a point-to-point connection to appliance 100 using an appliance which may take the form of a PC, for example.

The approach described herein enables field service personnel to diagnose appliance 100 via a radio connection 114. The requirement to prevent third parties from eavesdropping communication exist in the case of radio connection 114 as well. This is useful, for example, to protect know-how that is not to be disclosed to the public. Analogously to the optical transmission, a point-to-point connection is established in the radio-based approach as well. To prevent eavesdropping by third parties, radio connection 114 is encrypted using generally available cryptographic methods.

In accordance with an exemplary embodiment, it is ensured that only the personnel servicing household appliance 100 can establish an encrypted connection 114 to appliance 100.

IP-based diagnostic connections are protected using either shared keys for all appliances 100, 102 or certificates. However, using certificates is very complex and very difficult to implement in appliances 100, 102.

Certificates used for protection purposes can only provide sufficient security if the appliance 100, 102 that must validate the certificate has access to a revocation list. These lists are available via the Internet and, consequently, require Internet access. This access must be implemented parallel to point-to-point connection 114, which, however, is impossible, or very difficult, to accomplish when using a single air interface 110, 112, which may take the form of a single radio module.

Therefore, in an exemplary embodiment, a symmetrical signature based on a HMAC method is used.

This has the advantage that it is not necessary to provide all household appliances 100 with unique certificates, which would be very complex to accomplish because the corresponding production processes must be performed under secure conditions (in terms of IT security). Another obstacle would be that some products are manufactured by OEM partners. In such case, it would be very difficult to monitor secure procedures (in terms of IT security).

In an exemplary embodiment according to the approach described herein, only field service personnel is able to establish an encrypted connection to appliance 100. This may be accomplished using a shared secret (key) between the appliance and the field service personnel.

The simplest approach is to assign the same key to all appliances 100. However, this is important from a security standpoint because compromise of the key would allow access to all appliances 100. Therefore, it is expedient to use a unique key for each appliance 100. The challenge here is to store this unique key in appliance 100. Assigning the unique key during manufacture is very complex to accomplish, which applies analogously to certificates.

Therefore, in accordance with the approach described herein, a unique key 116 is generated for each appliance 100 using cryptographic methods. As a result, this means that each appliance 100 has a unique key 116 for performing radio-based diagnosis.

The operating principle of this approach will initially be generally described based on an operational sequence with reference to an exemplary embodiment. The steps mentioned below are successive in time.

First, field service personnel arrives at the location of appliance 100 and activates the radio connection of appliance 100. This may be done, for example, by pressing button 130 or in any other suitable way.

Appliance 100 then calculates a unique first key 116 from identification information 124 (hereinafter also referred to as serial number 124) and a general key 132 (hereinafter also referred to as KeyBase 132) which was previously stored in all or at least a plurality of appliances 100. Unique first key 116 is used for the diagnosis and is hereinafter also referred to as KeyDiagnosis 116.

Appliance 100 periodically sends certain information in unencrypted form, such as, for example, the general type of appliance; i.e., its technical type, as well as its serial number S#124. This sending may be via first air interface 110.

Using diagnostic device 102 (hereinafter also referred to as field service PC 102), a search for available radio connections is performed and appliance 100, its appliance type or technical type and serial number S#124 are found.

Field service PC 102 is adapted to calculate second key 118 (hereinafter also referred to as KeyDiagnosis 118) based on previously known KeyBase 132 and serial number S#124 for access to appliance 100.

Field service PC 102 is adapted to connect to appliance 100 using the previously calculated second key 118.

The approach described herein will now be explained in detail with reference to an exemplary embodiment.

Field service personnel arrives at the location of appliance 100 and activates the radio connection, here WLAN module 110, of appliance 100.

Next, appliance 100 calculates a unique key 116 for diagnosis from serial number S#124 and a KeyBase 132 previously stored in appliances 100. To this end, in an exemplary embodiment, initially a cryptographic signature method, here the cryptographic hash function called HMAC-SHA256, is used with the following parameter:

KeyTemp:=HMAC-SHA256(KeyBase, S#)

The result is a byte_array[32], which is also referred to as first pre-key. To be able to use this array as a WLAN key, the array is transformed into valid characters. This is done using a transformation rule for transforming the first pre-key. To this end, in this exemplary embodiment, the temporary result KeyTemp is Base64-encoded. The result is the temporary key KeyTemp2, which is also referred to as second pre-key.

KeyTemp2:=Base64(KeyTemp)

In the case of WLAN, this key is shortened to a maximum length of 32 characters. If necessary, the key length may be further reduced. This is done using a suitable trimming rule. In accordance with this exemplary embodiment, the reduction to length LKey is effected by the function Trim, which cuts off all characters after LKey. The result is KeyDiagnosis 116.

KeyDiagnosis:=Trim (LKey, KeyTemp2)

Subsequently, appliance 100 activates a so-called soft access point (soft AP), which may represent an access point of first air interface 110 that is implemented in software. In accordance with an exemplary embodiment, the wireless network name or network name SSID used by the appliance for the soft AP is as follows (the Random field is optional):

SSID:=<Technical type>-<Serial number>-<Random field>

e.g., SSID:=WMV 960-123456789-A0z

The SSID is periodically sent unencrypted as a beacon. In this way, identification information 124, which is in the form of the serial number and used for generating key 116, is sent unencrypted as part of the network name.

The key, which may be, for example, a Wi-Fi Protected Access (WPA) key, is the previously calculated KeyDiagnosis 116. Thus, the data transmitted via WLAN communication connection 114 in this embodiment is encrypted with first key 116 in the form of KeyDiagnosis 116.

Field service PC 102 performs a search for available WLAN networks, finds appliance 100 and is able to read its appliance type, technical type and serial number S#124 from the SSID sent by appliance 100.

Based on a previously known general key 132, here KeyBase 132, and using the same method by which first key 116 was calculated in appliance 100, field service PC 102 calculates second key 118, which also represents the KeyDiagnosis, for access to appliance 100.

Field service PC 102 connects to appliance 100 using the calculated second key 118.

In this connection, cryptographic function HMAC-SHA256 and Base64 encoding are mentioned merely by way of example. In principle, all cryptographic signature methods or so-called HMAC methods may be used here.

The special feature of the approach described herein is that key 116 can be easily calculated during operation by the software of appliance 100. Thus, a different and preferably unique key 116 can be generated for each appliance 100 with an otherwise identical software. In accordance with this exemplary embodiment, the basis for the calculation of unique key 116 is a shared key in the form of general key 132, which is stored in the software of the appliance and may be replaced during operation, for example, by a software update.

According to an exemplary embodiment, a new key 116 may be generated by the cryptographic algorithm for each diagnostic connection 114. This means that if another random parameter 134 is incorporated into network name SSID, then a new key 116 is generated for each soft AP generated by appliance 100 through application of the cryptographic hash function.

Thus, even in the event that shared key 116 becomes known, the previous data traffic cannot be decrypted because the random portion produced by random parameter 134 is not known.

In accordance with an exemplary embodiment, one feature of the approach is that identification information 124, on which WLAN keys 116, 118 at both ends are based, is sent when air interface 110 is activated and/or when the activation is initiated using a button 130. This makes it possible to connect to any appliance 102 without prior knowledge (except for the calculation rule and, if applicable, an additional shared secret) and without any preparatory steps, completely independently of identification information 124 because this information is communicated when necessary. In an exemplary embodiment, in order to avoid vulnerability to attacks in the event that the calculation rule becomes known, a randomly generated parameter 134 that is valid only once is considered and additionally used during generation. Here, too, it is necessary to communicate this parameter 134 in order to make this possible.

In accordance with an exemplary embodiment, information 124 is not just provided for transmission, but sent as soon as the method is executed. To this end, optionally, a (soft) AP of an infrastructure-based network is established, with identification information 124 being part of the network name. Random parameter 134 is valid for one connection only and then becomes invalid and/or must be generated anew. In this case, parameter 134 is sent together with identification information 124, for example, as part of the network name.

The automated generation of unique keys 116, 118 for protecting wireless local point-to-point connections 114, for example, for diagnosis by field service personnel, will be described with reference to general exemplary embodiments with the aid of the following figures.

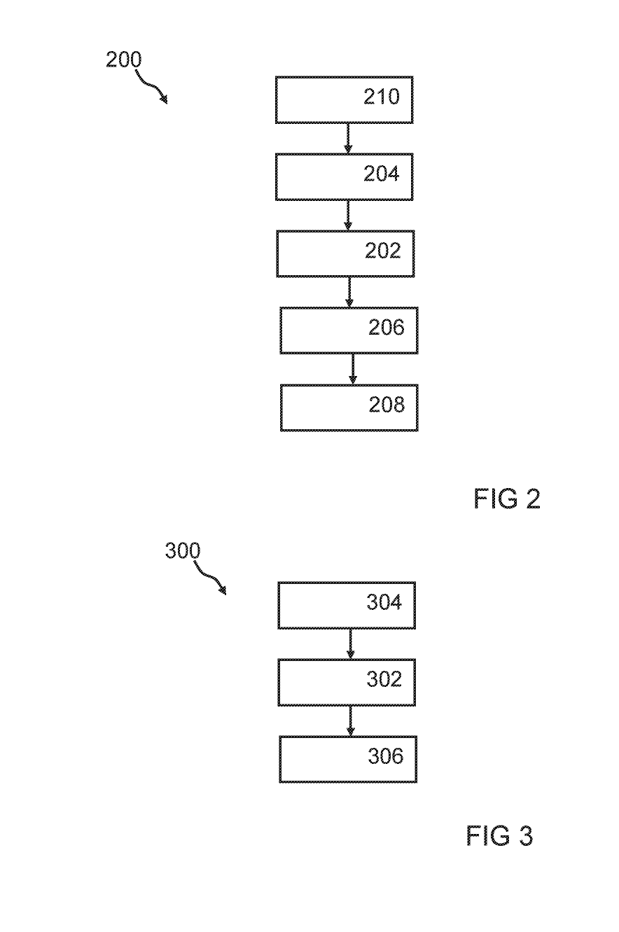

FIG. 2 shows a flow diagram of a method 200 for generating a first key in a household appliance in accordance with an exemplary embodiment. Method 200 may be implemented, for example, by units of the device of a household appliance such as are described with reference to FIG. 1.

Method 200 includes a determining step 202 in which the first key is determined using identification information associated with the household appliance and, optionally, a general key and, additionally or alternatively, a randomly generated parameter. Unless the data used for determining the first key is already available for use, it is read in a step 204. In a step 206, after the first key has been determined, it is made available for further use. To allow a second key to be generated in a further appliance (e.g., a diagnostic device) in parallel with or in a time-staggered manner with respect to the first key, method 200 includes a step 208 in which the data necessary for determining the second key, such as, for example, the identification information and, if applicable, the randomly generated parameter, is sent to the further appliance. In accordance with an exemplary embodiment, method 200 is initiated when an air interface of the household appliance is activated in a step 210.

FIG. 3 shows a flow diagram of a method 300 for generating a second key in an appliance in accordance with an exemplary embodiment. Method 300 may be implemented, for example, by units of the device of a diagnostic device that is described with reference to FIG. 1.

Method 300 includes a determining step 302 in which the second key is determined using identification information associated with a household appliance and, optionally, a general key and, additionally or alternatively, a randomly generated parameter. In a step 304, unless the data used for determining the second key is already available for use, it is received from the household appliance (e.g., the identification information and the randomly generated parameter) and/or is read from a storage unit of the appliance (e.g., the general key). In an optional step 306, after the second key has been determined, it is made available for further use.

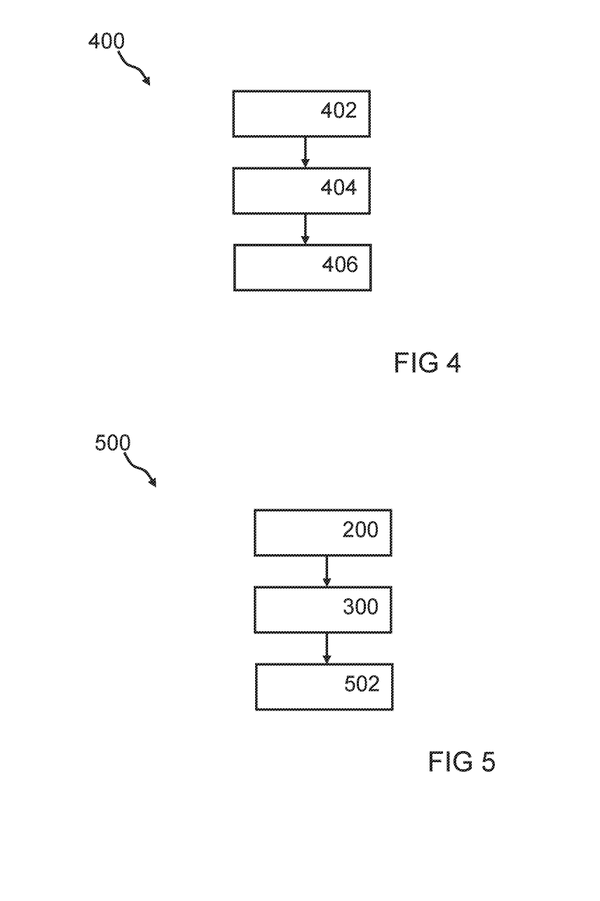

FIG. 4 shows a flow diagram of a method 400 for determining a key in accordance with an exemplary embodiment. Method 400 includes steps 402, 404, 406, which may be executed instead of steps 202, 302 in the methods described with reference to FIGS. 2 and 3.

In step 402, a pre-key is determined from the identification information and the general key using a cryptographic signature method. In step 404, a second pre-key is determined from the first pre-key using a transformation rule. In step 406, the first key, respectively the second key, is determined form the second pre-key using a trimming rule.

FIG. 5 shows a flow diagram of a method 500 for secure communication between a household appliance and an appliance in accordance with an exemplary embodiment. Method 500 includes the steps of methods 200, 300 according to which initially a first and second key are generated. At least some of the steps of methods 200, 300 may be performed concurrently. In a step 502, a secure communication connection is established and operated between the household appliance and the appliance using the first key and the second key.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for generating a key for secure communication between a household appliance and an appliance, the method comprising the following steps:
determining the key using identification information associated with the household appliance; and
sending the identification information via an air interface of the household appliance in order to transmit the identification information from the household appliance to the appliance.

2. The method as recited in claim 1, wherein the determining step is performed using a determining unit disposed or disposable in the household appliance.

3. The method as recited in claim 1, including a step of reading the identification information via an interface to a storage unit for storing the identification information, the storage unit representing a storage unit which is disposed or disposable in the household appliance.

4. The method as recited in claim 3, wherein the reading step is performed in response to an activation of an air interface of the household appliance for wireless communication between the household appliance and the appliance.

5. The method as recited in claim 1, including a step of establishing a soft access point or an access point of an infrastructure-based network, the identification information being part of the name of the network.

6. The method as recited in claim 1, wherein the identification information is transmitted unencrypted as part of a network name of the air interface.

7. The method as recited in claim 1, wherein the identification information represents a serial number of the household appliance.

8. The method as recited in claim 1, wherein in the step of determining the key, the key is determined further using a general key and/or a randomly generated parameter, the parameter being valid for one connection only, then becoming invalid, and being determined anew in a subsequent determining step; and
wherein in the sending step, the parameter is sent together with the identification information.

9. The method as recited in claim 8, wherein in the determining step, a first pre-key is determined from the identification information and the general key using a cryptographic signature method, a second pre-key is determined from the first pre-key using a transformation rule, and the key is determined from the second pre-key using a trimming rule.

10. A method for secure communication between a household appliance and an appliance, the method comprising the following steps:
generating a first key using a first determining unit disposed in the household appliance and performing the method according to claim 1;
generating a second key corresponding to the first key using a second determining unit disposed in the appliance and using the identification information sent via the air interface; and
establishing a secure communication connection between the household appliance and the appliance using the first key and the second key.

11. A device adapted to perform the steps of the method according to claim 1.

12. A household appliance having a device according to claim 11.

13. A non-transitory processor-readable medium having processor-executable instructions stored thereon for generating a key for secure communications between a household appliance and an appliance, wherein the processor-executable instructions, when executed, facilitate the following:
determining the key using identification information associated with the household appliance; and
sending the identification information via an air interface of the household appliance in order to transmit the identification information from the household appliance to the appliance.
